(19) United States
(12) Patent Application Publication
(10) Pub. No.: US 2026/0319332 A1
(43) Pub. Date: Oct. 15, 2026

(54) Variable Aperture Assembly with Anti-Backlash Blades

(71) Applicant: Apple Inc., Cupertino, CA (US)

(72) Inventors: Zhuzhen Ji, Sunnyvale, CA (US); Bin Xu, Sunnyvale, CA (US)

(73) Assignee: Apple Inc., Cupertino, CA (US)

(21) Appl. No.: 19/177,276

(22) Filed: Apr. 11, 2025

(51) Int. Cl. G03B 9/06; H04N 23/55

(52) U.S. Cl. CPC G03B 9/06; H04N 23/55

(57) ABSTRACT

A camera includes an optical assembly having one or more lenses. The camera also includes an image sensor. The camera further includes a variable aperture assembly positioned along a light path extending from an object side of the one or more lenses of the optical assembly and to the image sensor. The variable aperture assembly includes a rotor, a stator, a plurality of blades configured to vary a diameter of the aperture when the rotor rotates relative to the stator. The respective blades of the plurality of blades include a slot to receive pin extending from the stator. The variable aperture assembly also includes a rotor connection member for each of the plurality of blades for fixedly attaching the respective blade to the rotor. The variable aperture assembly further includes, for each of the respective blades, a biasing member configured to hold the pin against a side of the slot.

### BACKGROUND

### Technical Field

This disclosure relates generally to lens aperture for a camera module and, particularly to using anti-backlash blades with a variable aperture assembly.

### Description of the Related Art

The advent of small, mobile multipurpose devices such as smartphones and tablet or pad devices has resulted in a need for high-resolution, small form factor cameras for integration in the devices. Some cameras may incorporate optical image stabilization (OIS) mechanisms that may sense and react to external excitation/disturbance by adjusting location of the optical lens on the X and/or Y axis in an attempt to compensate for unwanted motion of the lens. Furthermore, some cameras may incorporate an autofocus (AF) mechanism whereby the object focal distance can be adjusted to focus an object plane in front of the camera at an image plane to be captured by the image sensor. Additionally, some cameras may incorporate a variable lens aperture for modulating the amount of light received by the lens(es). In some such variable lens aperture mechanisms, the variable lens aperture may be actuated using a variety of configurations to open and close the aperture.

### BRIEF DESCRIPTION OF THE DRAWINGS

FIGS. 1 and 2 illustrate components of an example camera having a variable aperture assembly that may, for example, change the diameter of an aperture/opening to change an amount of light that reaches lenses of an optical assembly and/or an image sensor in small form factor cameras, according to at least some embodiments. FIG. 1 shows an overhead view of the exterior of the camera. FIG. 2 shows a cross-sectional view of the camera.

FIG. 3 illustrates an overhead view of components of an example variable aperture assembly without anti-backlash blades that may, for example, be used to change the diameter of an aperture/opening to change an amount of light that reaches lenses of an optical assembly and/or an image sensor in small form factor cameras, according to at least some embodiments.

FIG. 4 illustrates an overhead view of an example variable aperture assembly with anti-backlash blades that may, for example, be used to change the diameter of an aperture/opening to change an amount of light that reaches lenses of an optical assembly and/or an image sensor in small form factor cameras, according to at least some embodiments.

FIG. 5 illustrates an overhead view of components of an example variable aperture assembly with anti-backlash blades that may, for example, be used to change the diameter of an aperture/opening to change an amount of light that reaches lenses of an optical assembly and/or an image sensor in small form factor cameras, according to at least some embodiments.

FIGS. 6 and 7 illustrate an overhead view of components of an example variable aperture assembly with anti-backlash blades that may, for example, be used to change the diameter of an aperture/opening to change an amount of light that reaches lenses of an optical assembly and/or an image sensor in small form factor cameras, according to at least some embodiments. FIG. 6 shows an overhead view of a blade of a variable aperture assembly in a first position. FIG. 7 shows an overhead view of a blade of a variable aperture assembly in a second position.

FIG. 8 illustrates an example method of assembling a variable aperture assembly with anti-backlash blades that may, for example, be used to change the diameter of an aperture/opening to change an amount of light that reaches lenses of an optical assembly and/or an image sensor in small form factor cameras, according to at least some embodiments.

FIGS. 9, 10, and 11 illustrate a perspective view of components of an example variable aperture assembly with anti-backlash blades that may, for example, be used to change the diameter of an aperture/opening to change an amount of light that reaches lenses of an optical assembly and/or an image sensor in small form factor cameras, according to at least some embodiments. FIG. 9 illustrates a rotor and a stator of the example variable aperture assembly. FIG. 10 illustrates a rotor, a stator, and a plurality of blades of the example variable aperture assembly. FIG. 11 illustrates a rotor, a stator, and a plurality of blades attached thereto of the example variable aperture assembly.

FIG. 12A illustrates an overhead view of a blade of an example variable aperture assembly, according to at least some embodiments.

FIGS. 12B and 12C illustrate an overhead view of various biasing members of an example variable aperture assembly with anti-backlash blades, according to at least some embodiments.

FIGS. 13A and 13B illustrate an overhead view of various biasing members of an example variable aperture assembly with anti-backlash blades, according to at least some embodiments.

FIGS. 14, 15, and 16 illustrate overhead views of another example variable aperture assembly with anti-backlash blades that may, for example, be used to change the diameter of an aperture/opening to change an amount of light that reaches lenses of an optical assembly and/or an image sensor in small form factor cameras, according to at least some embodiments. FIG. 14 illustrates an overhead view of the variable aperture assembly in a fully actuated position. FIG. 15 illustrates an overhead view of the variable aperture assembly in a partially actuated position between the fully actuated position and a fully open position. FIG. 16 illustrates an overhead view of the variable aperture assembly in the fully open position.

FIG. 17 illustrates a schematic representation of an example device that may include a camera, in accordance with some embodiments.

FIG. 18 illustrates a schematic block diagram of an example computing device, referred to as computer system, that may include or host embodiments of a camera, in accordance with some embodiments.

This specification includes references to “one embodiment” or “an embodiment.”The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units ....” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine a based on B.” While in this case, b is a factor that affects the determination of A, such a phrase does not foreclose the determination of a from also being based on C. In other instances, a may be determined based solely on B.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the intended scope. The first contact and the second contact are both contacts, but they are not the same contact.

The terminology used in the description herein is for the purpose of describing particular embodiments only and is not intended to be limiting. As used in the description and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

### DETAILED DESCRIPTION

Various embodiments described herein relate to a variable aperture assembly, for a camera module (e.g., a small form factor camera module) that may be positioned over an aperture. The aperture may allow/permit light from an external environment or exterior region (e.g., external to the camera module, from an object-side of an optical assembly along a light path) to pass therethrough to one or more lenses of the camera module and/or an image sensor of the camera module. The variable aperture assembly may change or vary (e.g., modulate) a diameter of the aperture to change an amount of light from the external environment that reaches the lenses and/or the image sensor of the camera module. In some aspects, variable aperture assemblies may include blades coupled to a rotor via a pin extending from the rotor and into an opening through the blade. The blade may also include a slot to receive another pin extending from a stator. As the rotor moves (for example, rotates) relative to the stator and thus as the blade moves via the pin attaching the rotor to the blade, the pin extending from the stator moves along a length of the slot causing the blade to rotate inward or outward depending on the directional movement (for example, rotation) of the rotor to decrease or increase a diameter of the aperture.

However, because of a gap formed between the opening of the blade and the pin extending from the rotor and through the opening and/or because of a gap formed within the slot between the other pin extending from the stator and a wall of the slot, a blade backlash may occur contemporaneously with actuation of the blades and potentially decreasing the responsiveness and/or effectiveness of the variable aperture assembly. For example, due to the aforementioned one or more gaps, a delay may occur between when the rotor begins to move (for example, rotate) and when the blades begin to actuate. As another example, due to the aforementioned one or more gaps, when the rotor ceases moving relative to the stator, the blades may continue to move at least the distance of the one or more gaps. As yet another example, due to the aforementioned one or more gaps, the blades may not fully close the aperture or may not reach a desired aperture diameter after actuating from an open position. As another example, due to the aforementioned one or more gaps, the blades may not fully open the aperture or may not reach a desired aperture diameter after actuating from a closed or partially closed position.

As described herein, a camera module may include an optical assembly having one or more lenses, an image sensor, and a variable aperture assembly. The variable aperture assembly may be positioned along a light path extending from an object side of the one or more lenses of the optical assembly and to the image sensor. The variable aperture assembly may include a rotor, a stator, and a plurality of blades. The plurality of blades may be configured to vary a diameter of an aperture when the rotor rotates relative to the stator. Each of the plurality of blades may include a slot to receive a pin extending from the stator. The variable aperture assembly may also include a rotor connection member for each of the blades for fixedly attaching a respective blade to the rotor and a biasing member configured to bias the pin against a side of the slot. In some aspects, the biasing member may be positioned adjacent the rotor connection member. The biasing member may include one of a spiral spring surrounding the rotor connection member or a plurality of arms surrounding the rotor connection member and extending from the respective blades and towards the rotor connection member. The biasing member may be positioned adjacent the pin and the slot. The biasing member may include a ring wrapping at least partially around the pin and abutting the pin to bias the pin against at least the side of the slot. In some aspects, the biasing member may include a flexible wall of the slot configured to flex so that the pin fits through the slot and bias the pin at least against the side of the slot. The rotor connection member may include at least one of a press-fit mechanism or an adhesive. For example, the rotor connection member may include a receiver to receive a pin from rotor that press-fits the pin therein securing a blade to the rotor. As another example, the rotor connection member may include a glue that adheres the rotor to a blade at a particular location of the blade and the rotor. In some aspects, each biasing member for the respective blades may bias the variable aperture assembly toward an open position or alternatively to a closed position. In some aspects, the camera module may include one or more actuators configured to rotate the rotor relative to the stator to drive the plurality of blades for varying the diameter of the aperture. The one or more actuators may include at least one of a voice coil motor (VCM) actuator or a shape memory alloy (SMA) wire actuator.

As described herein, various variable aperture assemblies (for example, for a camera module), as described herein, may reduce or eliminate backlash due to the gap formed between the opening of the blade and the pin extending from the rotor and through the opening and/or due to the gap formed within the slot between the other pin extending from the stator and a wall of the slot. By reducing or eliminating the aforementioned one or more gaps, backlash may be reduced or eliminated, sensitivity of tolerance to blade tolerance may be reduced or eliminated improving an aperture quality, sensing errors may be reduced improving close loop control accuracy, and the manufacturing process may be de-risked and improved without the need to ensure that tight clearances exist. For example, due to little or no gaps at one or more of the aforementioned locations, a delay may be reduced or may not occur between when the rotor begins to move (for example, rotate) and when the blades begin to actuate. As another example, due to little or no gaps at one or more of the aforementioned locations, when the rotor ceases moving relative to the stator, the time that passes between when the rotor ceases moving and when the blades cease moving may decrease or may be reduced to zero or near zero. As yet another example, due to little or no gaps at one or more of the aforementioned locations, the blades may fully close the aperture, may more fully close the aperture, and/or may reach a desired aperture diameter after actuating from an open position. As another example, due to little or no gaps at one or more of the aforementioned locations, the blades may fully open the aperture, may more fully close the aperture, or may reach a desired aperture diameter after actuating from a closed or partially closed position.

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that some embodiments may be practiced without these specific details. In other instances, well-known methods, procedures, components, circuits, and networks have not been described in detail so as not to unnecessarily obscure aspects of the embodiments.

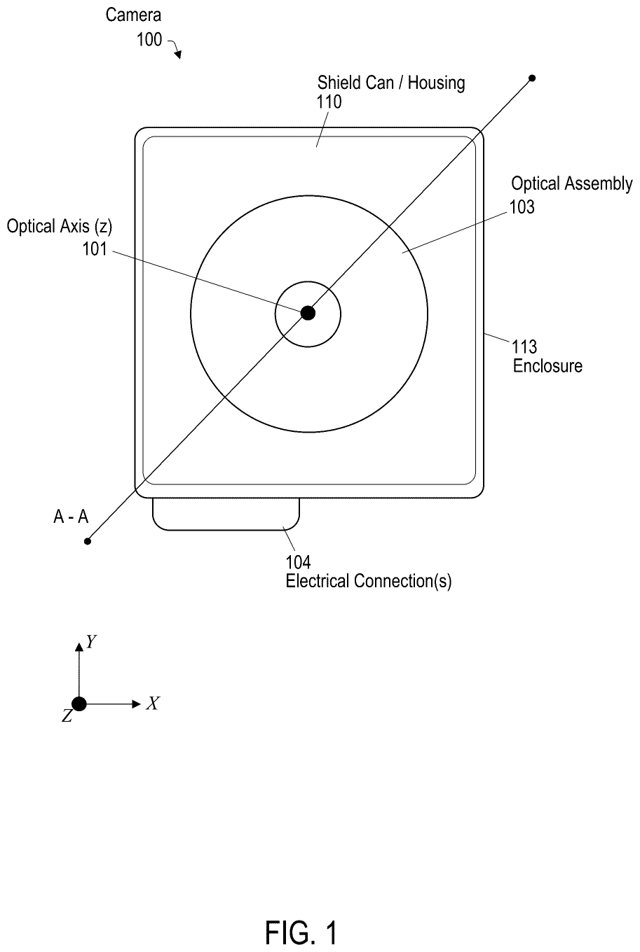

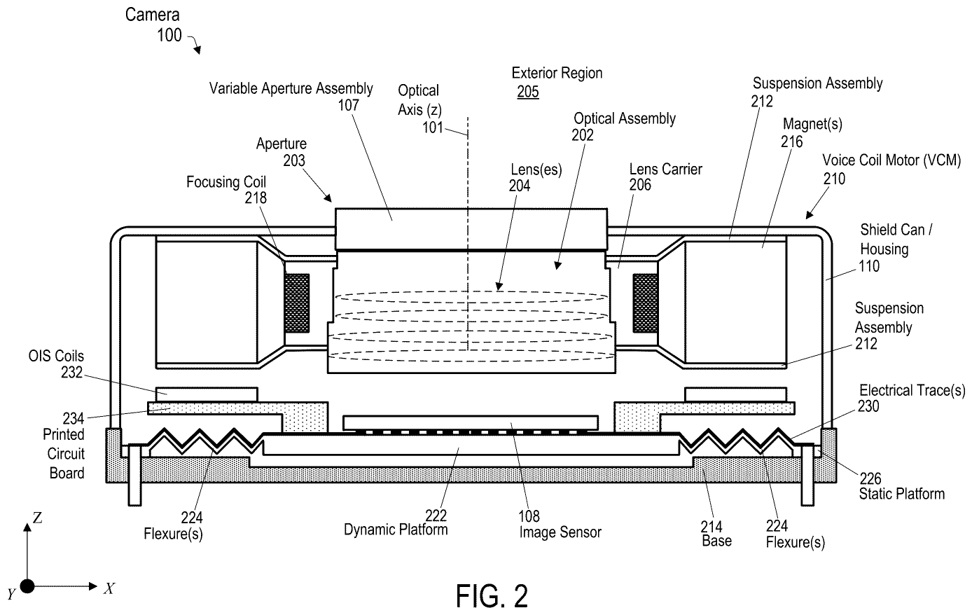

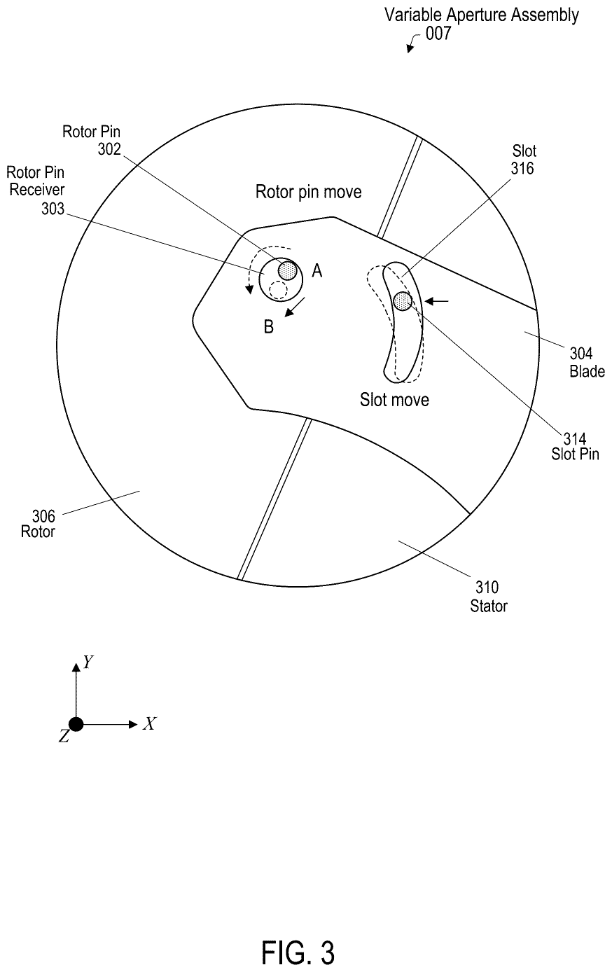

FIGS. 1 and 2 illustrate components of an example camera having a variable aperture assembly that may, for example, change the diameter of an aperture/opening to change an amount of light that reaches lenses of an optical assembly and/or an image sensor in small form factor cameras, according to at least some embodiments. FIG. 1 shows an overhead view of the exterior of the camera. FIG. 2 shows a cross-sectional view of the camera. The camera 100 of FIGS. 1 and 2 may include one or more same or similar features as the features described with respect to or illustrated in FIGS. 3, 4a, 4b, 4c, 5, 6a, 6b, 6c, 7, and 8. The example X-Y-Z coordinate system shown in FIGS. 1 and 2 may be used to discuss aspects of components and/or systems, and may apply to embodiments described throughout this disclosure.

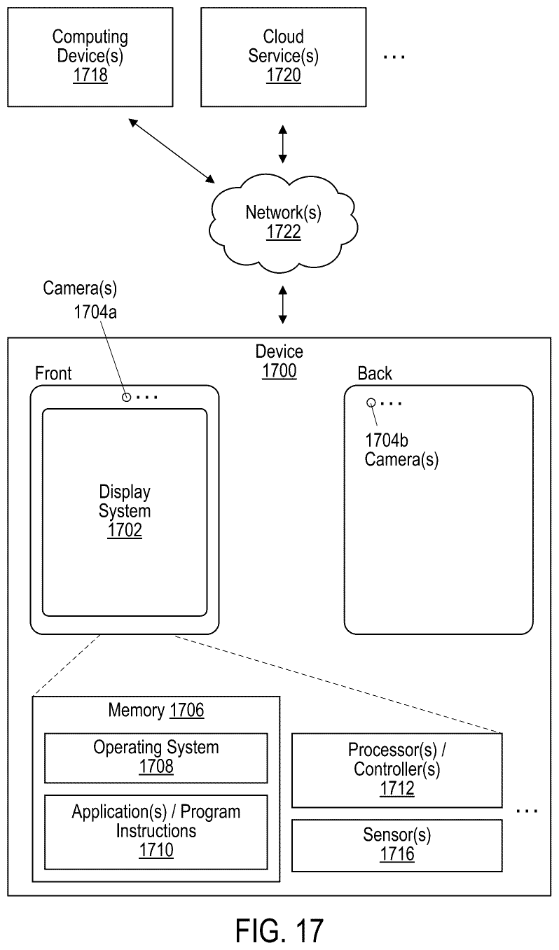

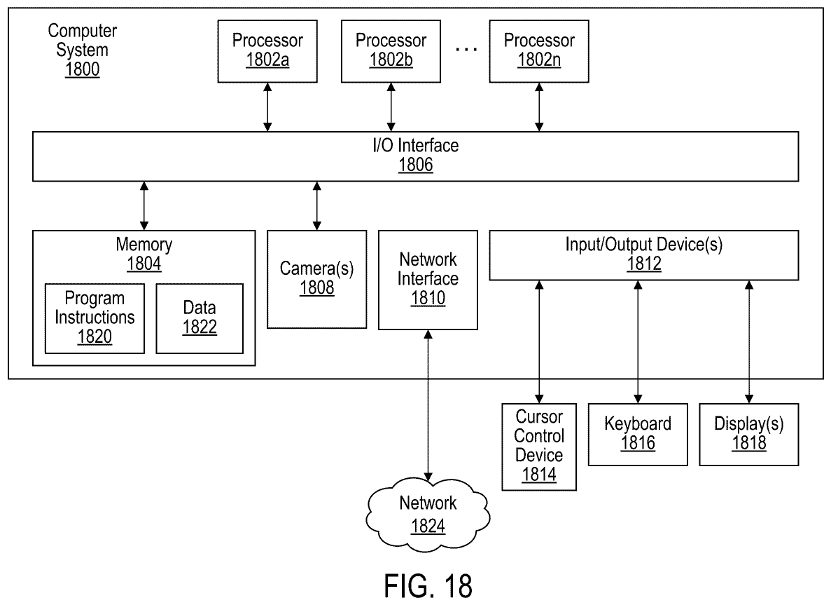

In various embodiments, the camera 100 may include an optical assembly 103 having one or more lenses 204 defining an optical axis (z) 101, a shield can or housing 110, an enclosure or base 113, and electrical connection(s) 104. The shield can 110 may form an outer wall of a top portion (and in some cases side portions) of the camera 100 and form one or more camera shoulders. The enclosure 113 may form an outer wall of a bottom portion (and in some cases side portion(s)) of the camera 100. The electrical connection(s) 104 may extend from the enclosure 113 (and/or the shield can 110) and may electrically connect the camera 100 to an external device. For example, the camera 100 may be the same or similar camera as the camera 1704b illustrated in FIG. 17 or the camera 1808 illustrated in FIG. 18. As such, the electrical connection(s) 104 may extend from the enclosure 113 and may electrically connected the camera 100 to the device 1700 illustrated in FIG. 17 or the computer system 1800 illustrated in FIG. 18, respectively. In some aspects, the camera 100 may include autofocus (AF) cameras (e.g., movement of the image sensor 208 (e.g., illustrated in FIG. 2) and/or the optical assembly 103 in the z-direction along the optical axis) and/or may include optical image stabilization (OIS) (e.g., movement of the image sensor 208 and/or the optical assembly 103 in one or more directions orthogonal to (x-direction, y-direction) or not parallel to the optical axis 101) of the image sensor 208 and/or the optical assembly 103. The variable aperture assembly 107 may be aligned with the optical axis 101 and the lenses 204 of the optical assembly 103 over an aperture/opening 203. The variable aperture assembly 107 may be configured to change or vary (e.g., modulate) the diameter of the aperture 203 to change an amount of light that reaches the lenses 204 of the optical assembly 103 and/or the image sensor 208 in small form factor cameras 100, as described further herein.

In various embodiments, the camera 100 may also include a flexure 221, an actuator assembly 210, a substrate 234 (e.g., an OIS flexible printed circuit (FPC), printed circuit board, and/or the like), the image sensor 208, and filter(s) 209 positioned between the optical assembly 103 and the image sensor 208. The flexure 221 may include a dynamic platform 222, a static platform 226, and a plurality of flexure arms 224. The flexure 221 may be connected to an interior surface of the shield can 110 and/or the enclosure 113 via a static platform 226. The flexure 221 may also retain the substrate 234, the image sensor 208, and the filter(s) 209 via the dynamic platform 222. The plurality of flexure arms 224 may provide a flexible mechanical coupling between the static platform 226 and the dynamic platform 222. For example, the flexure arms 224 may allow the dynamic platform 221 to move in one or more directions orthogonal to the optical axis 101 relative to the static platform 226 (e.g., and a remainder of the camera 100) using components of the actuator assembly 210. For example, the actuator assembly 210 may include the magnet(s) 216 fixedly attached to an interior surface of the shield can 110 (e.g., via the suspension assembly 212, via direct attachment to the interior surface of the shield can 110) and the OIS coils 232 mounted on the substrate 234. Pairs of magnets 216 and OIS coils 232 may together be a voice coil motor (VCM). A magnetic field from respective magnets 216 may interact with current flowing through the respective OIS coils 232 creating Lorentz forces to move the dynamic platform 222 including the substrate 234 and the image sensor 208 in one or more directions orthogonal (e.g., x-direction, y-direction) to the optical axis 101. In some aspects, the flexure arms 224 may include electrical traces 230 for communicating electrical power and electrical signals between the dynamic platform 222 (e.g., one or more electronic components mounted on the substrate 234, the image sensor 208 mounted on the substrate 234, one or more electronic components mounted to the dynamic platform 222, or the like) and the static platform 226. The static platform 226 may be in electrical communication with one or more other components of the camera 100, via an electrical connection, for performing one or more camera operations.

In some non-limiting examples, the image sensor 208 may be attached to or otherwise integrated into the substrate 234, such that the image sensor 208 is connected to the OIS frame or flexure 221 via the substrate 234. For example, the dynamic platform 222 may retain the substrate 234 for mounting one or more electronic components and/or the image sensor 208. In some aspects, the substrate 234 may include an opening with a cross-section sized to permit light to pass therethrough while also receiving or retaining the filter(s) 209 and the image sensor 208. The substrate 234 may retain the filter(s) 209 and the image sensor 208 around a perimeter of the opening. In some aspects, the image sensor 208 may be retained on the top surface of the substrate 234 while the filter(s) 209 may be positioned between the optical assembly 103 and the image sensor 208. These configuration may allow the substrate 234 to retain the image sensor 208 (and in some cases the filter(s) 209) while also allowing light to pass from the lens(es) 204 of the optics assembly 103, through the filter(s) 209, and be received by the image sensor 208 for image capturing. In other embodiments, the substrate 234 and the image sensor 208 may be separately attached to the OIS frame or flexure 220. For instance, a first set of one or more electrical traces 216 may be routed between the substrate 234 and the OIS frame or flexure 221. A second, different set of one or more electrical traces 216 may be routed between the image sensor 208 and the OIS frame or flexure 221.

In some aspects, the camera 100 may include the optical assembly 103 including the one or more lenses 204, a lens carrier 206, and a suspension assembly 212. The actuator assembly 210 may move the optical assembly 103 along the optical axis 101 to provide autofocus. For example, the actuator assembly 210 may include the magnets 216 and the focusing coils 218 attached to the lens carrier 206. The respective magnets 216 and the respective focusing coils 218 may together be a voice coil motor (VCM). A magnetic field from the magnets 216 may interact with current flowing through the focusing coils 218 creating Lorentz forces to move the optical assembly 103 including the lenses 204 along the optical axis 101 (e.g., in the z-direction) for autofocus. The suspension assembly 212 may be attached to both an interior surface of the shield can 110 and the lens carrier 206 and provide damping of movement of the optical assembly 103 in the z-direction along the optical axis 101. The suspension assembly 212 may retain the optics assembly 102 within a z-range of motion relative to the shield can 110 and/or the image sensor 208 during activation of the actuator assembly 210 for autofocus.

The camera 100 may also include an aperture 203 formed through the shield can 110 and centered on the optical axis 101 for allowing light to pass from the exterior environment 205 (e.g., an object side of the optical assembly 103) and through the shield can 110 and to the lenses 204 of the optical assembly 103 and/or the image sensor 208. A variable aperture assembly 107 may be positioned within and/or over the aperture 203. As described herein, the variable aperture assembly 107 may change or vary (e.g., modulate) a diameter of the aperture 203 to change an amount of light that passes therethrough and reaches the lenses 204 and/or the image sensor 208 of the camera module 100.

FIG. 3 illustrates an overhead view of components of an example variable aperture assembly without anti-backlash blades that may, for example, be used to change the diameter of an aperture/opening to change an amount of light that reaches lenses of an optical assembly and/or an image sensor in small form factor cameras, according to at least some embodiments. The variable apertures 007 may be implemented with and/or include one or more same or similar features as the features described with respect to or illustrated in FIGS. 1, 2, 4, 5, 6, 7, 8, 9, 10, 11, 12A, 12B, 12C, 13A, 13B, 14, 15, 16, 17, and 18. The example X-Y-Z coordinate system shown in FIG. 3 may be used to discuss aspects of components and/or systems, and may apply to embodiments described throughout this disclosure.

As shown in FIG. 3, the variable aperture assembly 007 may include a rotor 306, a stator 310, an aperture 203 positioned in the center of the rotor 306 and the stator 310 and centered about the optical axis 101, and a plurality of blades 304 (e.g., overlapping mechanical blades) that actuate to change the diameter of an aperture/opening to change an amount of light that reaches lens(es) of an optical assembly and/or an image sensor of the camera module 100 (e.g., a small form factor camera). The variable aperture assembly 007 includes one or more actuators such as one or more VCM actuators and/or one or more shape memory alloy (SMA) wire actuators. The one or more actuators may be for moving the rotor 306 relative to the stator 310. For example, the one or more actuators may be positioned on a side of the variable aperture assembly 007 perpendicular to the optical axis 101. In some aspects, the variable aperture assembly 007 may include a plurality of actuators positioned around the variable aperture assembly 007. For example, the variable aperture assembly 007 may include at least two actuators positioned 180 degrees apart from each other. As another example, the variable aperture assembly 007 may include at least three actuators positioned 120 degrees apart from each other. As yet another example, the variable aperture assembly 007 may include at least four actuators positioned 90 degrees apart from each other. The VCM actuator(s) may include magnets and coil(s). For example, the coil(s) may be fixedly attached to the rotor 306 and the magnet(s) may be fixedly attached to the stator 310. When current flows through the coil(s) fixedly attached to the rotor 306 and within a magnetic field produced from magnet(s) fixedly attached to the stator 310, the Lorentz forces generated by the interaction between the electric field from the coil(s) and the magnetic field from the magnet(s) causes the rotor 306 to move or rotate relative to the stator 310 actuating the blades 304 and causing the diameter of an aperture/opening 203 to change an amount of light that reaches the lens(es) 204 of an optical assembly 206 and/or an image sensor 108.

The variable aperture assembly 007 may also include rotor pin 302 and rotor pin receiver 303. The rotor pin 302 may extend from the rotor 306. The rotor pin receiver 303 may be an aperture, cavity, or through hole formed in a respective blade 304. For example, the rotor pin 302 may extend from the rotor 306 and through (for example, into, completely through, partially through) the rotor pin receiver 303. When the rotor pin 302 extends from the rotor 306 and through the rotor pin receiver 303, the blade 304 couples to the rotor 306. For example, an engagement between the rotor pin 302 and the rotor pin receiver 303 may couple the blade 304 to the rotor 306 while allowing some motion (for example, rotational movement) of the blade 304 relative the rotor 306. However, often due to machining, molding, and/or forming of the rotor pin 302 and the rotor pin receiver 303, for example, a gap may form between edges of the rotor pin receiver 303 and the surface of the rotor pin 302. This gap may allow the rotor pin 302 to move translationally within the rotor pin receiver 303. Thus, backlash of the blade 304 may occur contemporaneously with actuation of rotor 306 and the blades 304 and potentially decreasing the responsiveness and/or effectiveness of the variable aperture assembly 007. For example, due to the aforementioned gap, a delay may occur between when the rotor 306 begins to move (for example, rotate) and when the blades 304 begin to actuate. As another example, due to the aforementioned gap, when the rotor 306 ceases moving relative to the stator 310, the blades 304 may continue to move at least the distance of the gap. As yet another example, due to the aforementioned gap, the blades 304 may not fully close the aperture or may not reach a desired aperture diameter after actuating from an open position. As another example, due to the aforementioned gap, the blades 304 may not fully open the aperture or may not reach a desired aperture diameter after actuating from a closed or partially closed position. 972-567-8509

The variable aperture assembly 007 may further include slot pin 314 and a slot 316. The slot pin 314 may extend from the stator 310. The slot 316 may be an aperture, cavity, or through-hole formed in a respective blade 304. The slot pin 314 may extend from the stator 310 and through (for example, into, completely through, partially through) the slot 316. When the slot pin 314 extends from the stator 310 and through the slot 316, the blade 304 couples to the stator 306. The slot 316 may also have a profile or shape such as a curve that controls where and/or how the far the blade 304 moves when the rotor 306 rotates relative to the stator 310. For example, an engagement between the slot pin 314 and the pin 316 may couple the blade 304 to the stator 310 while allowing motion of the blade 304 relative the stator 310 along the profile of the slot 316. However, often due to machining, molding, and/or forming of the slot pin 314 and the slot 316, for example, a gap may form between edges of the slot 316 and the surface of the pin 314. This gap allows the rotor pin 302 to move in directions that are not in accordance with the profile of the slot 316. Thus, backlash of the blade 304 may occur contemporaneously with actuation of rotor 306 and the blades 304 and potentially decreasing the responsiveness and/or effectiveness of the variable aperture assembly 007. For example, due to the aforementioned gap, a delay may occur between when the rotor 306 begins to move (for example, rotate) and when the blades 304 begin to actuate. As another example, due to the aforementioned gap, when the rotor 306 ceases moving relative to the stator 310, the blades 304 may continue to move at least the distance of the gap. As yet another example, due to the aforementioned gap, the blades 304 may not fully close the aperture or may not reach a desired aperture diameter after actuating from an open position. As another example, due to the aforementioned gap, the blades 304 may not fully open the aperture or may not reach a desired aperture diameter after actuating from a closed or partially closed position.

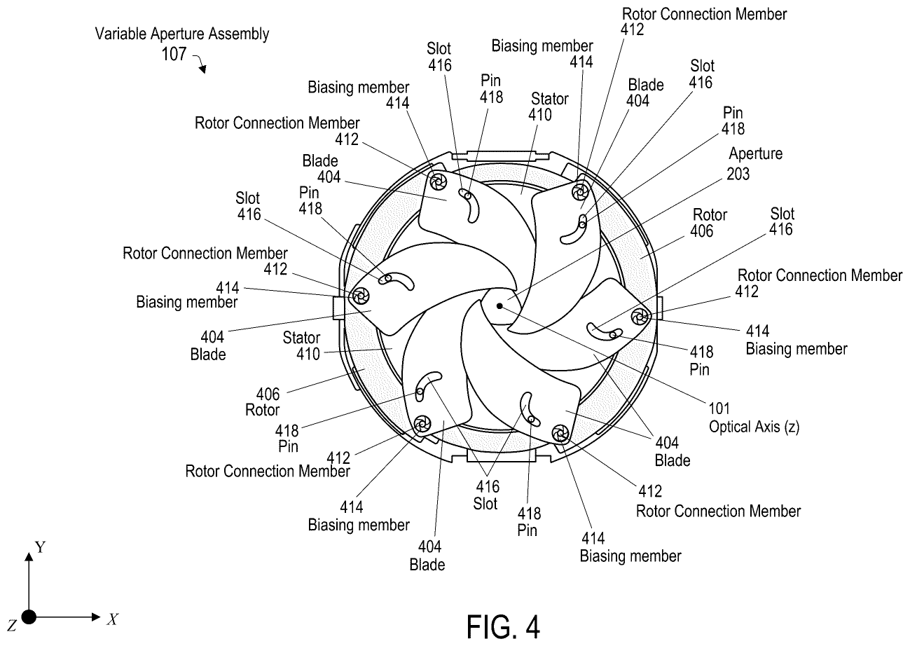

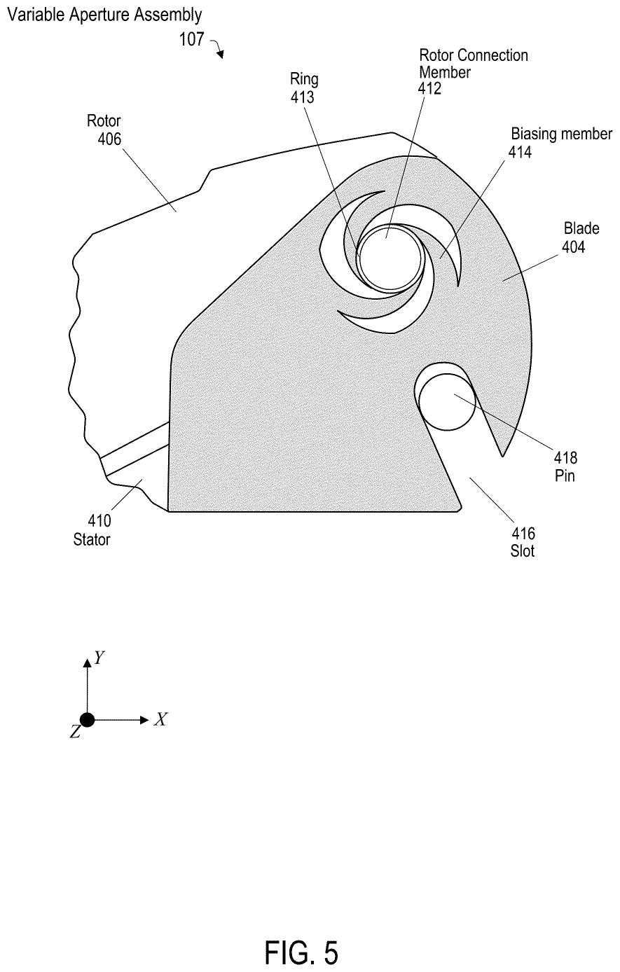

FIG. 4 illustrates an overhead view of an example variable aperture assembly with anti-backlash blades that may, for example, be used to change the diameter of an aperture/opening to change an amount of light that reaches lenses of an optical assembly and/or an image sensor in small form factor cameras, according to at least some embodiments. FIG. 5 illustrates an overhead view of components of an example variable aperture assembly 107 with anti-backlash blades that may, for example, be used to change the diameter of an aperture/opening to change an amount of light that reaches lenses of an optical assembly and/or an image sensor in small form factor cameras, according to at least some embodiments. The variable apertures 107 may be implemented with and/or include one or more same or similar features as the features described with respect to or illustrated in FIGS. 1, 2, 3, 6, 7, 8, 9, 10, 11, 12A, 12B, 12C, 13A, 13B, 14, 15, 16, 17, and 18. The example X-Y-Z coordinate system shown in FIGS. 4 and 5 may be used to discuss aspects of components and/or systems, and may apply to embodiments described throughout this disclosure.

The variable aperture assembly 107 may include a rotor connection member 412. The rotor connection member 412 may couple (for example, attach, fixedly attach) the rotor 406 to each blade 404 of the plurality of blades 404 such that each blade 404 moves with the rotor 406 when the rotor 406 moves. The rotor connection member 412 may include a pin receiver such as an aperture, cavity, or through-hole formed in a respective blade 404 for receiving a pin extending from the rotor 406. Additionally, or alternatively, the rotor connection member 412 may include a press-fit coupling that fixedly attaches the respective blades 404 to the rotor 406. For example, the rotor connection member 412 may include a press-fit receiver positioned on the respective blade 404 so that a press-fit protrusion (for example, a pin) extending from the rotor 406 may be received by the press-fit receiver for coupling (for example, securely fastening) the respective blade 404 to the rotor 406 so that the respective blade 404 moves with the rotor 406 when the rotor 406 moves. Additionally, or alternatively, the rotor connection member 412 may include an adhesive (for example, a glue) coupling the respective blade 404 to the rotor 406 so that the respective blade 404 moves with the rotor 406 when the rotor 406 moves. In some aspects, the rotor connection member 412 may include a ring 413 that secure fits around the pin extending from the rotor 406. The ring 413 may securely fit around the pin extending from the rotor 406 so that little or no gap exists between the rotor connection member 412 and the pin extending from the rotor 406. The springs of the biasing member 414 may be fixedly attached to the ring 413 so that biasing member 414 may be torqued as described herein. In some aspects, the ring 413 may be attached to the pin of the rotor 406 and/or the rotor connection member 412 via an adhesive. The adhesive may be permitted to cure (for example, using heat and/or ultraviolet let) before subsequent use of the variable aperture assembly 107. In some aspects, the rotor connection member 412 may be an aperture through the blade 404 for receiving a pin extending from the rotor 406. Additionally, or alternatively, the rotor connection member 412 may be a pin receiver (for example, a press-fit pin receiver) attached to the blade 404 for receiving a pin extending from the rotor 406. Additionally, or alternatively, the rotor connection member 412 may be a pin extending from the rotor 406 and pin receiver attached to the blade 404 for receiving the pin extending from the rotor 406. Additionally, or alternatively, the rotor connection member 412 may including an adhesive fixedly attaching the rotor 406 and the blade 404. Additionally, or alternatively, the rotor connection member 412 may including an adhesive fixedly attaching a ring 413 of the biasing member 414 to a pin extending from the rotor 406 and/or a pin receiver attached to the blade 404 for receiving the pin extending from the rotor 406.

The variable aperture assembly 107 may include biasing member(s) 414 for respective blades 404. Biasing member(s) 414 may be positioned on respective blades 404, on pin(s) 418 extending from the stator 410 for respective blades 404, and in slot(s) 416 positioned at least partially through respective blades 404 for receiving a respective pin 418. The respective slots 416 may be an aperture, cavity, or through-hole formed in a respective blade 404. The pins 418 may extend from the stator 410 and through (for example, into, completely through, partially through) the slot 416. When the pin 418 extends from the stator 410 and through the slot 416, the blade 404 couples to the stator 410. The slot 416 may also have a profile or shape such as a curve that controls where and/or how the far the blade 404 moves when the rotor 406 rotates relative to the stator 410. For example, an engagement between the pin 418 and the slot 416 may couple the blade 404 to the stator 410 while allowing motion of the blade 404 relative the stator 410 along the profile of the slot 416.

The biasing member(s) 414 may be configured to prevent or at least reduce backlash of the blade(s) 404 that may otherwise occur contemporaneously with actuation of rotor 406 and the blades 404 relative to the stator 410 to potentially increase the responsiveness and/or effectiveness of the variable aperture assembly 107. For example, when the rotor connection member(s) 412 include a pin receiver, such as an aperture, cavity, or through-hole formed in the respective blades 40 for receiving a pin extending from the rotor 406, the biasing member(s) 414 may be positioned at or near respective rotor connection member(s) 412 to reduce and/or eliminate any gap that may otherwise form between the pins and the pin receivers such that the respective blades 404 move with the rotor 406 when the rotor 406 moves with little or no delay between when the rotor 406 begins to move (for example, rotate) and when the blades 404 begin to actuate. In addition, the biasing member(s) 414 may be configured to hold or bias the pin(s) 418 extending from the stator 410 for respective blades 404 against a side wall of the slot(s) 416 positioned at least partially through respective blades 404 so that a desired aperture diameter may be attained after actuating the blades 404 from a first position to a second position. In some aspects, the biasing member(s) 414 may allow movement (for example, rotation) of the blade(s) 404 about the rotor connection member(s) 412 when the rotor 406 and the blade(s) 404 move together and relative to the stator 410 to hold or bias the pin(s) 418 extending from the stator 410 for respective blades 404 against a side wall of the slot(s) 416. For example, due to the biasing member(s) 414, the blades 404 may fully close the aperture 203 or may reach a desired aperture diameter after actuating from an open position by biasing or biasing the pin(s) 418 against a side wall of the slot(s) 416. As another example, due to the biasing member(s) 414, the blades 404 may fully open the aperture 203 or may reach a desired aperture diameter after actuating from a closed or partially closed position by biasing or biasing the pin(s) 418 against a side wall of the slot(s) 416. As described herein, the biasing member(s) 414 may be positioned at or near the rotor connection members 412 and/or at or near the slot(s) 416 and pin(s) 418. As shown in FIG. 5, the biasing member 414 may include curved arms extending from the blade 414 and to the rotor connection member 412. The curved arms may provide rotational spring force to bias the pin 418 against a wall of the slot 416. It should be understood that a biasing member 414 may hold a pin 418 against a wall of the slot 416 due to frictional forces between arms of the biasing member 414 and the rotor connection member 412. Additionally, or alternatively, a biasing member 414 may bias a pin 418 against a wall of the slot 416 due to loaded rotational or spring forces from the arms in a flexed position.

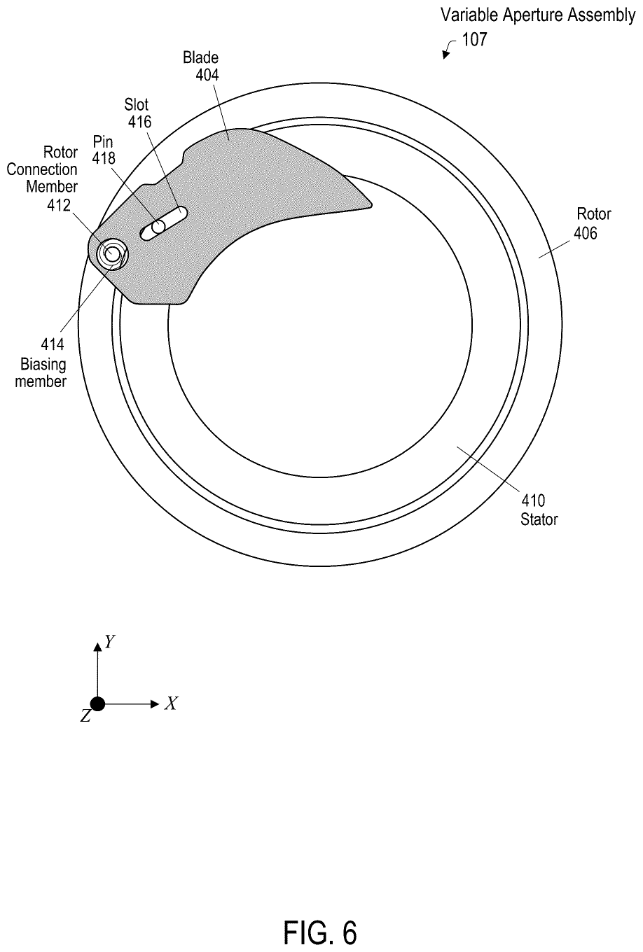

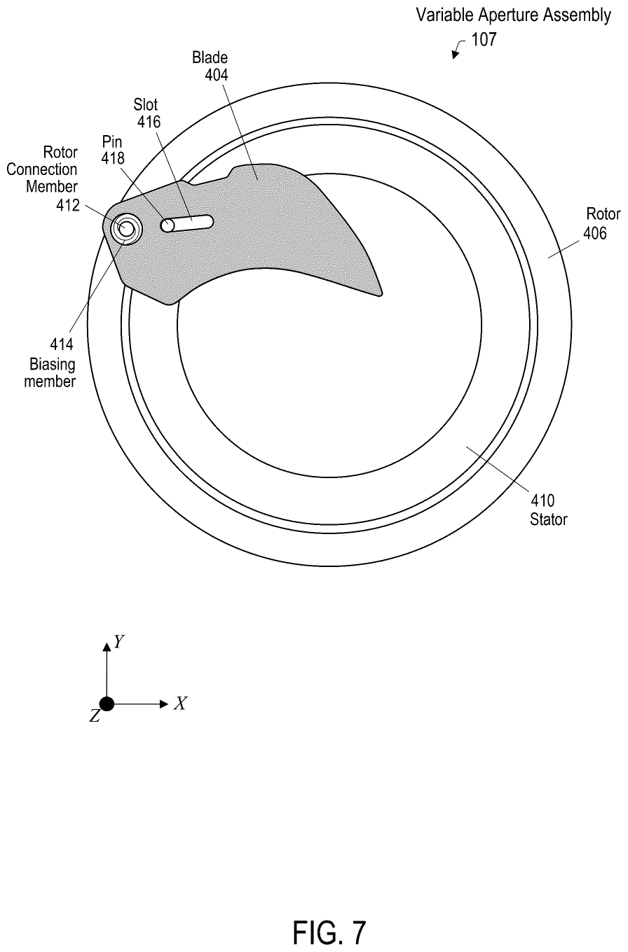

FIGS. 6 and 7 illustrate an overhead view of components of an example variable aperture assembly 107 with anti-backlash blades that may, for example, be used to change the diameter of an aperture/opening to change an amount of light that reaches lenses of an optical assembly and/or an image sensor in small form factor cameras, according to at least some embodiments. FIG. 6 shows an overhead view of a blade of a variable aperture assembly 107 in a first position. FIG. 7 shows an overhead view of a blade of a variable aperture assembly 107 in a second position. The variable apertures 107 may be implemented with and/or include one or more same or similar features as the features described with respect to or illustrated in FIGS. 1, 2, 3, 4, 5, 8, 9, 10, 11, 12A, 12B, 12C, 13A, 13B, 14, 15, 16, 17, and 18. The example X-Y-Z coordinate system shown in FIGS. 6 and 7 may be used to discuss aspects of components and/or systems, and may apply to embodiments described throughout this disclosure.

As indicated herein, FIG. 6 shows an overhead view of a blade of a variable aperture assembly 107 in a first position. As shown in FIG. 6, the variable aperture assembly 107 may be in an open position such as a fully open position or a partially open position (for example, a non-closed position) such that the diameter of an aperture 203 is relatively large and allows a relatively large amount of light to reach lenses of an optical assembly and/or an image sensor in small form factor cameras. As previously described, the rotor connection member 412 may couple (for example, attach, fixedly attach) the rotor 406 to the blade 404 such that each blade 404 moves with the rotor 406 when the rotor 406 moves. The rotor connection member 412 may include a pin receiver such as an aperture, cavity, or through-hole formed in a respective blade 404 for receiving a pin extending from the rotor 406. Additionally, or alternatively, the rotor connection member 412 may include a press-fit coupling that fixedly attaches the respective blades 404 to the rotor 406. For example, the rotor connection member 412 may include a press-fit receiver positioned on the respective blade 404 so that a press-fit protrusion (for example, a pin) extending from the rotor 406 may be received by the press-fit receiver for coupling (for example, securely fastening) the respective blade 404 to the rotor 406 so that the respective blade 404 moves with the rotor 406 when the rotor 406 moves. Additionally, or alternatively, the rotor connection member 412 may include an adhesive (for example, a glue) coupling the respective blade 404 to the rotor 406 so that the respective blade 404 moves with the rotor 406 when the rotor 406 moves.

The variable aperture assembly 107 may include biasing member(s) 414 for respective blades 404. Biasing member(s) 414 may be positioned on respective blades 404, on pin(s) 418 extending from the stator 410 for respective blades 404, and in slot(s) 416 positioned at least partially through respective blades 404 for receiving a respective pin 418. The respective slots 416 may be an aperture, cavity, or through-hole formed in a respective blade 404. The pins 418 may extend from the stator 410 and through (for example, into, completely through, partially through) the slot 416. When the pin 418 extends from the stator 410 and through the slot 416, the blade 404 couples to the stator 410. The slot 416 may also have a profile or shape such as a curve that controls where and/or how the far the blade 404 moves when the rotor 406 rotates relative to the stator 410. For example, an engagement between the pin 418 and the slot 416 may couple the blade 404 to the stator 410 while allowing motion of the blade 404 relative the stator 410 along the profile of the slot 416.

The biasing member(s) 414 may be configured to prevent or at least reduce backlash of the blade(s) 404 that may otherwise occur contemporaneously with actuation of rotor 406 and the blades 404 relative to the stator 410 to potentially increase the responsiveness and/or effectiveness of the variable aperture assembly 107. For example, when the rotor connection member(s) 412 include a pin receiver, such as an aperture, cavity, or through-hole formed in the respective blades 40 for receiving a pin extending from the rotor 406, the biasing member(s) 414 may be positioned at or near respective rotor connection member(s) 412 to reduce and/or eliminate any gap that may otherwise form between the pins and the pin receivers such that the respective blades 404 move with the rotor 406 when the rotor 406 moves with little or no delay between when the rotor 406 begins to move (for example, rotate) and when the blades 404 begin to actuate. In addition, the biasing member(s) 414 may be configured to hold or bias the pin(s) 418 extending from the stator 410 for respective blades 404 against a side wall of the slot(s) 416 positioned at least partially through respective blades 404 so that a desired aperture diameter may be attained after actuating the blades 404 from a first position to a second position. In some aspects, the biasing member(s) 414 may allow movement (for example, rotation) of the blade(s) 404 about the rotor connection member(s) 412 when the rotor 406 and the blade(s) 404 move together and relative to the stator 410 to hold or bias the pin(s) 418 extending from the stator 410 for respective blades 404 against a side wall of the slot(s) 416. For example, due to the biasing member(s) 414, the blades 404 may fully close the aperture 203 or may reach a desired aperture diameter after actuating from an open position by biasing or biasing the pin(s) 418 against a side wall of the slot(s) 416. As another example, due to the biasing member(s) 414, the blades 404 may fully open the aperture 203 or may reach a desired aperture diameter after actuating from a closed or partially closed position by biasing or biasing the pin(s) 418 against a side wall of the slot(s) 416. For example, as shown in FIG. 6, the biasing member 414 may bias the pin 418 against a side of the slot 416 due to a biasing force or a torsion force created by the biasing member 414 and applied to the blade 404 and the pin 418.

As described herein, FIG. 7 shows an overhead view of a blade of a variable aperture assembly 107 in a second position. As shown in FIG. 7, the variable aperture assembly 107 may be in a closed position such as a fully closed position or a partially closed position (for example, a position that is not fully open) such that the diameter of the aperture 203 is relatively small or smaller than when the variable aperture assembly 107 is at the first position and allows a relatively large amount of light to reach lenses of an optical assembly and/or an image sensor in small form factor cameras compared to when the variable aperture assembly 107 is at the first position. For example, one or more actuators may have caused the rotor 406 to move relative to the stator 410. Because the rotor 406 has moved relative to the stator 410, the blades 404 may have also moved or rotated relative to the stator 410 and towards the center of the aperture 203 (for example, towards the optical axis). During movement of the blades 404 relative to the stator 410, the biasing member 414 may bias the pin 418 against a side of the slot 416 so that the second position is a desired blade position resulting in a desired aperture diameter for a desired amount of light to pass therethrough. In some aspects, the biasing member 414 may also reduce and/or eliminate any gap that may otherwise form at the rotor connection member 412 such that the respective blades 404 move with the rotor 406 when the rotor 406 moves with little or no delay between when the rotor 406 begins to move (for example, rotate) and when the blades 404 begin to actuate.

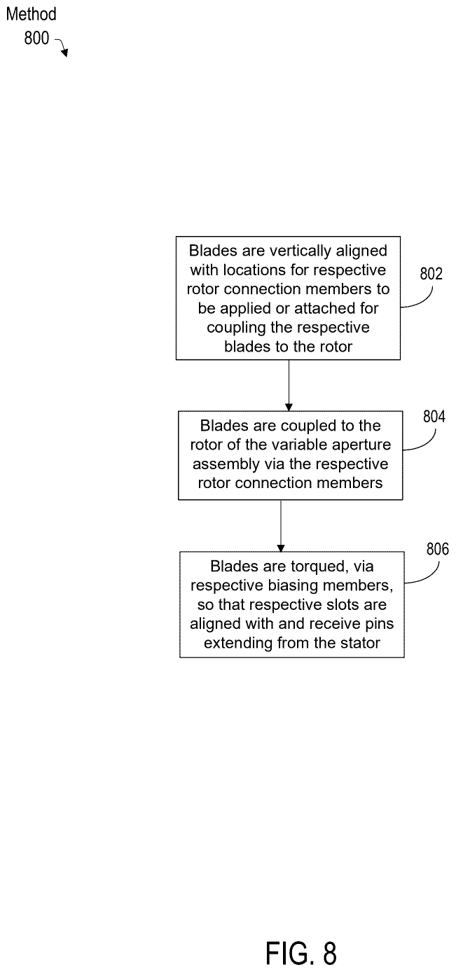

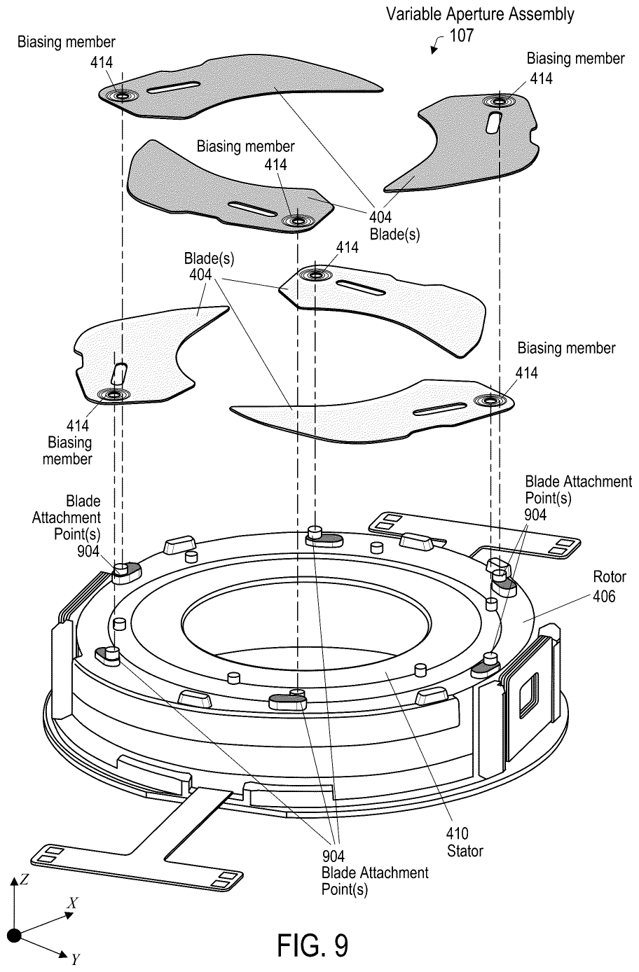

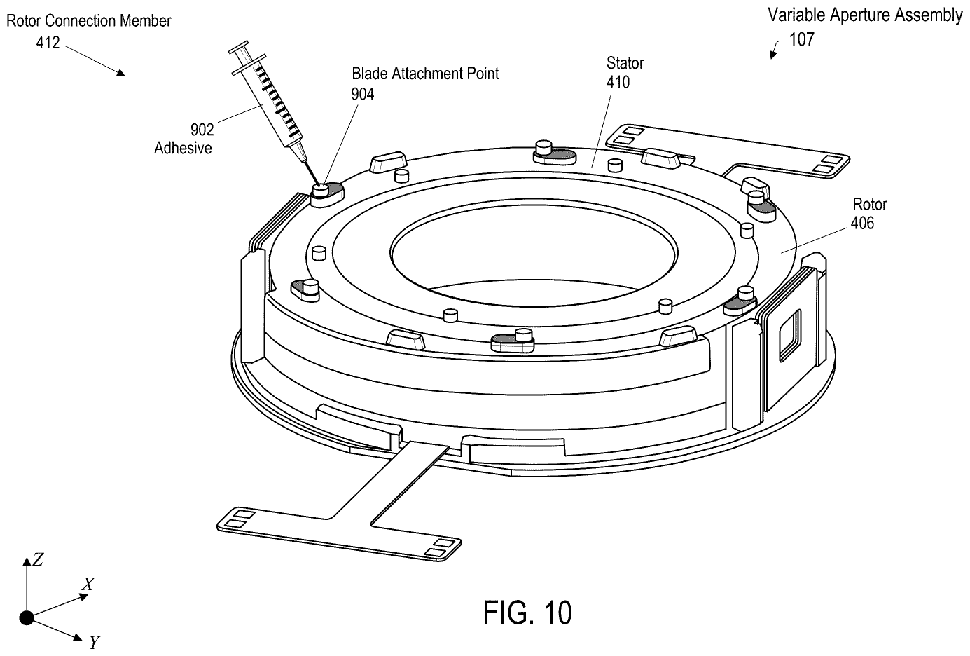

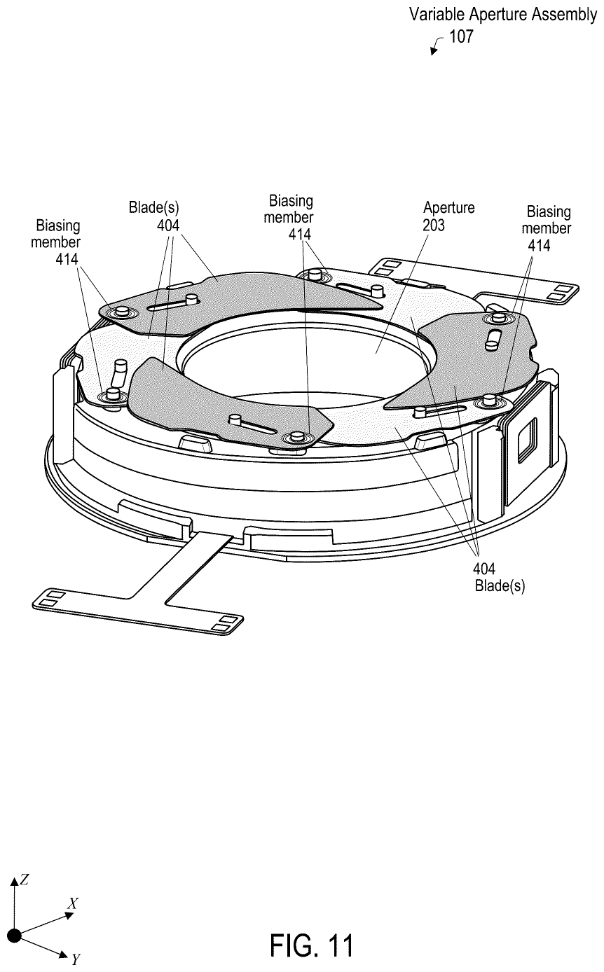

FIG. 8 illustrates an example method 800 of assembling a variable aperture assembly 107 with anti-backlash blades that may, for example, be used to change the diameter of an aperture/opening to change an amount of light that reaches lenses of an optical assembly and/or an image sensor in small form factor cameras, according to at least some embodiments. FIGS. 9, 10, and 11 illustrate at least some steps of the example method 800 with perspective views of components of an example variable aperture assembly 107 with anti-backlash blades that may, for example, be used to change the diameter of an aperture/opening to change an amount of light that reaches lenses of an optical assembly and/or an image sensor in small form factor cameras, according to at least some embodiments. FIG. 9 illustrates a rotor, a stator, and a plurality of blades of the example variable aperture assembly 107. FIG. 10 illustrates a rotor and a stator of the example variable aperture assembly 107. FIG. 11 illustrates a rotor, a stator, and a plurality of blades attached thereto of the example variable aperture assembly 107. The method 800 may be implemented with and/or include one or more same or similar features as the features described with respect to or illustrated in FIGS. 1, 2, 3, 4, 5, 6, 7, 12A, 12B, 12C, 13A, 13B, 14, 15, 16, 17, and 18. The example X-Y-Z coordinate system shown in FIGS. 9, 10, and 11 may be used to discuss aspects of components and/or systems, and may apply to embodiments described throughout this disclosure.

At step 802, blades 404 are vertically aligned with locations for respective rotor connection members 412 to be applied or attached for coupling the respective blades 404 to the rotor 406 of the variable aperture assembly 107. For example, points or locations on each of the blades 404 may be aligned with locations for respective rotor connection members 412 for coupling respective blades 404 with the rotor 406 around the rotor 406. In some aspects, a second portion of the respective rotor connection member(s) 412 attached or applied to respective blades 404 may be aligned with a first portion of respective rotor connection member(s) 412 attached or applied to the rotor 406 for coupling respective blades 404 with the rotor 406 at various locations around the rotor 406. Additionally, or alternatively, as shown in FIG. 9, the blades 404 may be aligned with blade attachment points or locations 904 on the rotor such that the biasing member 414 of the respective blades 404 vertically align with the blade attachment points or locations 904. In some aspects, the slot 416 of the blade 404 may be aligned with the pin 418 of the stator 410 so that when the blade 404 is attached to the rotor 406, the pin 418 extends at least partially into the slot 416. In some aspects, the blade 404 may be aligned with locations on the rotor 406 for attachment via the rotor connections member 412 with the rotor 406. Additionally, the slot 416 of the blade 404 may be offset from the pin 418 of the stator 410 so that when the blade 404 is attached to the rotor 406, the blade 404 and/or the rotor connection member 412 may be torqued or loaded with rotational tension to enable the pin 418 to extend at least partially into the slot 416. This may allow the biasing members, as described herein, to bias the pin 418 against a wall of the slot 416. In some aspects, the rotor connection member 412 may include a ring 413 that secure fits around the pin extending from the rotor 406. The ring 413 may securely fit around the pin extending from the rotor 406 so that little or no gap exists between the rotor connection member 412 and the pin extending from the rotor 406. The springs 1206 of the biasing member 414 may be fixedly attached to the ring 413 so that the springs 1206 of the biasing member 414 may be torqued as described herein. In some aspects, the ring 413 may be attached to the pin of the rotor 406 and/or the rotor connection member 412 via an adhesive. The adhesive may be permitted to cure (for example, using heat and/or ultraviolet let) before subsequent use of the variable aperture assembly 107.

In some aspects, rotor connection member(s) 412 are applied or attached to respective locations of a rotor of a variable aperture assembly. The rotor connection member 412 may couple (for example, attach, fixedly attach) the rotor 406 to each blade 404 of the plurality of blades 404 such that each blade 404 moves with the rotor 406 when the rotor 406 moves. In some aspects, a first portion of respective rotor connection member(s) 412 may be attached or applied to the rotor 406 and a second portion of the respective rotor connection member(s) 412 may be attached or applied to respective blades 404. For example, the rotor connection member 412 may include a pin formed by or attached to the rotor 406 and extending from the rotor 406 and received by a pin receiver such as an aperture, cavity, or through-hole formed in a respective blade 404. Additionally, or alternatively, the rotor connection member 412 may include a press-fit coupling that fixedly attaches the respective blades 404 to the rotor 406. For example, the rotor connection member 412 may include a pin formed by or attached to the rotor 406 and extending from the rotor 406 and a receiver formed by and positioned on the respective blade 404 so that receiver may receive the pin and couple the respective blade 404 to the rotor 406 so that the respective blade 404 moves with the rotor 406 when the rotor 406 moves. Additionally, or alternatively, as shown in FIG. 10, the rotor connection member 412 may include an adhesive 904 (for example, a glue) dispensed at several different blade attachment points or locations 904 on the rotor 406 coupling the respective blade 404 to the rotor 406 so that the respective blade 404 moves with the rotor 406 when the rotor 406 moves.

At step 804, blades 404 are coupled to the rotor 406 of the variable aperture assembly 107 via the respective rotor connection members 412. For example, the rotor connection member 412 may include a pin extending from the rotor 406 and received by a pin receiver such as an aperture, cavity, or through-hole formed in a respective blade 404. Additionally, or alternatively, the rotor connection member 412 may include a press-fit coupling that fixedly attaches the respective blades 404 to the rotor 406. For example, the rotor connection member 412 may include a pin extending from the rotor 406 and a receiver positioned on the respective blade 404 so that receiver may receive pin and couple the respective blade 404 to the rotor 406 so that the respective blade 404 moves with the rotor 406 when the rotor 406 moves. Additionally, or alternatively, as shown in FIG. 11, the rotor connection member 412 may attach the respective blades 404 to the rotor 406 at the location of the respective biasing members 414 via the adhesive 902 (for example, a glue) located at the blade attachment points or locations 904 so that the respective blades 404 move with the rotor 406 when the rotor 406 moves. In some aspects, when the rotor connection member 412 includes an adhesive, after the blades 404 are coupled to the rotor 406, the adhesive may be cured via heat and/or ultraviolet light.

As described herein, the biasing member(s) 414 may be configured to prevent or at least reduce backlash of the blade(s) 404 that may otherwise occur contemporaneously with actuation of rotor 406 and the blades 404 relative to the stator 410 to potentially increase the responsiveness and/or effectiveness of the variable aperture assembly 107. For example, when the rotor connection member(s) 412 include a pin extending from the rotor 406 and received by a pin receiver such as an aperture, cavity, or through-hole formed in the respective blades 404, the biasing member(s) 414 may be positioned at or near respective rotor connection member(s) 412 to reduce and/or eliminate any gap that may otherwise form between the pins and the pin receivers such that the respective blades 404 move with the rotor 406 when the rotor 406 moves with little or no delay between when the rotor 406 begins to move (for example, rotate) and when the blades 404 begin to actuate. In some aspects, the biasing member(s) 414 may allow movement (for example, rotation) of the blade(s) 404 about the rotor connection member(s) 412 when the rotor 406 and the blade(s) 404 move together and relative to the stator 410 to hold or bias the pin(s) 418 extending from the stator 410 for respective blades 404 against a side wall of the slot(s) 416. For example, as shown in FIG. 6, the biasing member 414 may hold or bias the pin 418 against a side of the slot 416 due to a biasing force or a torsion force created by the biasing member 414 and applied to the blade 404 and the pin 418.

At step 806, the blades are torqued, via respective biasing members, so that respective slots are aligned with and receive pins extending from the stator. For example, the biasing member(s) 414 may be configured to hold or bias the pin(s) 418 extending from the stator 410 for respective blades 404 against a side wall of the slot(s) 416 positioned at least partially through respective blades 404 so that a desired aperture diameter may be attained after actuating the blades 404 from a first position to a second position. The blades 404 may be secured to the rotor 406 so that initially the pin 418 extending from the stator 410 does not align with the slot 416. The blade 404 may be torqued, via the biasing member 414 so that the pin 418 extends into the slot 416 and is biased against a surface of the slot 416.

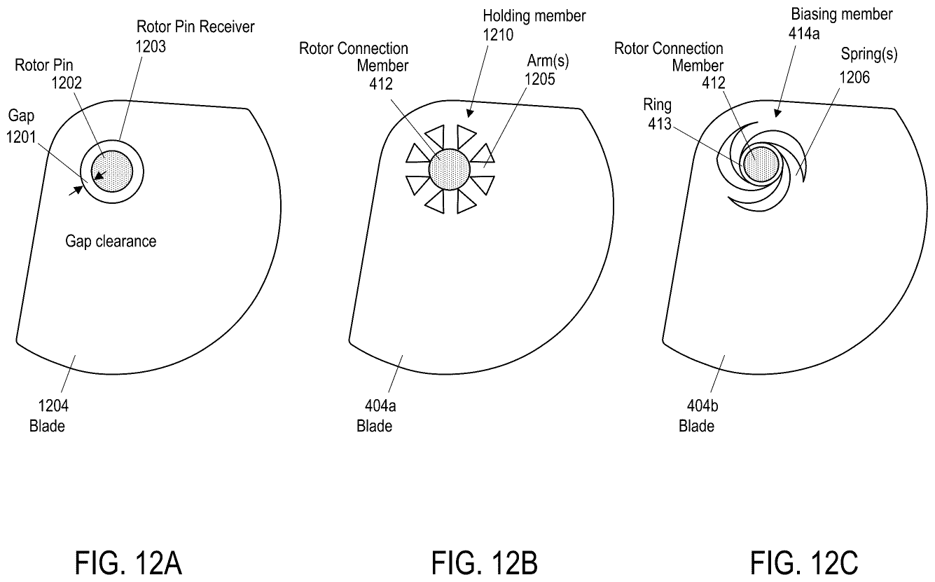

FIG. 12A illustrates an overhead view of a blade 1204 of a variable aperture assembly without anti-backlash blades that may, for example, be used to change the diameter of an aperture/opening to change an amount of light that reaches lenses of an optical assembly and/or an image sensor in small form factor cameras, according to at least some embodiments. The blade 1204 may be implemented with and/or include one or more same or similar features as the features described with respect to or illustrated in FIGS. 1, 2, 3, 4, 5, 6, 7, 8, 9, 10, 11, 12B, 12C, 13A, 13B, 14, 15, 16, 17, and 18. The example X-Y-Z coordinate system shown in FIG. 12A may be used to discuss aspects of components and/or systems, and may apply to embodiments described throughout this disclosure. In some aspects, the blade 1204 illustrated in FIG. 12A may include one or more same or similar features as the blade 304 illustrated in FIG. 3.

As shown in FIG. 12A, the blade 1204 may include rotor pin 1202 and rotor pin receiver 1203. The rotor pin 1202 may extend from a rotor. The rotor pin receiver 1203 may be an aperture, cavity, or through-hole formed in a respective blade 1204. For example, the rotor pin 1202 may extend from the rotor and through (for example, into, completely through, partially through) the rotor pin receiver 1203. When the rotor pin 1202 extends from the rotor and through the rotor pin receiver 1203, the blade 1204 couples to the rotor. For example, an engagement between the rotor pin 1202 and the rotor pin receiver 1203 may couple the blade 1204 to the rotor while allowing some motion (for example, rotational movement) of the blade 1204 relative the rotor. However, often due to machining, molding, and/or forming of the rotor pin 1202 and the rotor pin receiver 1203, for example, a gap 1201 may form between edges of the rotor pin receiver 1203 and the surface of the rotor pin 1202. The gap 1201 may allow the rotor pin 1202 to move translationally within the rotor pin receiver 1203. Thus, backlash of the blade 1204 may occur contemporaneously with actuation of rotor and the blades 1204 and potentially decrease the responsiveness and/or effectiveness of the variable aperture assembly. For example, due to the gap 1201, a delay may occur between when the rotor 1206 begins to move (for example, rotate) and when the blades 1204 begin to actuate. As another example, due to the gap 1201, when the rotor ceases moving relative to the stator, the blades 1204 may continue to move at least the distance of the gap 1201. As yet another example, due to the gap 1201, the blades 1204 may not fully close the aperture or may not reach a desired aperture diameter after actuating from an open position. As another example, due to the gap 1201, the blades 1204 may not fully open the aperture or may not reach a desired aperture diameter after actuating from a closed or partially closed position.

FIGS. 12B and 12C illustrate an overhead view of various biasing members of an example variable aperture assembly with anti-backlash blades, according to at least some embodiments. The blade 404a illustrated in FIG. 12B and/or blade 404b illustrated in FIG. 12C may be implemented with and/or include one or more same or similar features as the features described with respect to or illustrated in FIGS. 1, 2, 3, 4, 5, 6, 7, 8, 9, 10, 11, 12A, 13A, 13B, 14, 15, 16, 17, and 18. The example X-Y-Z coordinate system shown in FIGS. 12B and 12C may be used to discuss aspects of components and/or systems, and may apply to embodiments described throughout this disclosure.

As shown in FIG. 12B, a blade 404a may include a holding member 1210 having a plurality of arms 1205 and a rotor connection member 412. The rotor connection member 412 may couple (for example, attach, fixedly attach) a rotor to the blade 404a of a plurality of blades 404a such that each blade 404a moves with the rotor when the rotor moves. The rotor connection member 412 may include a pin receiver such as an aperture, cavity, or through-hole formed in a respective blade 404a, for receiving a pin extending from the rotor. Additionally, or alternatively, the rotor connection member 412 may include a press-fit coupling that fixedly attaches the respective blades 404a to the rotor. For example, the rotor connection member 412 may include a pin receiver positioned on the respective blade 404a for receiving a pin extending from the rotor so that the respective blade 404a moves with the rotor when the rotor moves. Additionally, or alternatively, the rotor connection member 412 may include an adhesive (for example, a glue) coupling the respective blade 404a to the rotor so that the respective blade 404a moves with the rotor when the rotor moves.

The blade 404a may include a holding member 1210 positioned on the blade 404a. As shown in FIG. 12B, the holding member 1210 may include a plurality of arms 1205 surrounding the rotor connection member 412 and extending from the blade 404a and towards the rotor connection member 412 in a radial configuration. When a pin extends from a stator and through the slot formed in the blade 404a, the blade 404a couples to the stator. The slot may also have a profile or shape such as a curve that controls where and/or how the far the blade 404a moves when the rotor rotates relative to the stator. For example, an engagement between the pin and the slot may couple the blade 404a to the stator while allowing motion of the blade 404a relative the stator along the profile of the slot. The holding member 1210 may be configured to prevent or at least reduce a gap between a pin extending from the rotor 406 and a pin receiver of the blade 404a. The arms 1205 may directly engage with the pin of the rotor 406 so that no gap or little gap exists between the pin extending from the rotor 406 and the pin receiver and/or so that no movement or less movement occurs between the pin extending from the rotor 406 and the pin receiver to potentially increase the responsiveness and/or effectiveness of the variable aperture assembly. For example, when the rotor connection member 412 includes a pin receiver such as an aperture, cavity, or through-hole formed in the respective blades 404a for receiving a pin extending from the rotor, the biasing member 414a may be positioned at or near respective rotor connection member 412 to reduce and/or eliminate any gap that may otherwise form between the pins and the pin receivers such that the respective blades 404a move with the rotor when the rotor moves with little or no delay between when the rotor begins to move (for example, rotate) and when the blades begin to actuate. In addition, the holding member 1210 may use the frictional force between the arms 1205 and surface(s) of the rotor connection member 412 to hold the pin extending from the rotor 406 in the pin receiver of the blade 404a. The arms 1205 against the pin extending from the rotor 406 may, in some examples, form a press-fit connection between the blade 404a and rotor connection member 412 and the pin extending from the rotor 406.

As shown in FIG. 12C, a blade 404b may include a biasing member 414a having a plurality of springs 1206 and a rotor connection member 412. The rotor connection member 412 may couple (for example, attach, fixedly attach) a rotor to the blade 404b of a plurality of blades 404b such that each blade 404b moves with the rotor when the rotor moves. The rotor connection member 412 may include a pin receiver such as an aperture, cavity, or through-hole formed in a respective blade 404b for receiving a pin extending from the rotor. Additionally, or alternatively, the rotor connection member 412 may include a press-fit coupling that fixedly attaches the respective blades 404a to the rotor. For example, the rotor connection member 412 may include a pin extending from the rotor and a receiver positioned on the respective blade 404b so that the receiver may receive the pin and couple the respective blade 404b to the rotor so that the respective blade 404b moves with the rotor when the rotor moves. Additionally, or alternatively, the rotor connection member 412 may include an adhesive (for example, a glue) coupling the respective blade 404b to the rotor so that the respective blade 404b moves with the rotor when the rotor moves.

The blade 404b may include a biasing member 414a positioned on the blade 404b. As shown in FIG. 12C, the biasing member 414a may include a plurality of springs 1206 surrounding the rotor connection member 412 and extending from the blade 404b and connected to the rotor connection member 412 in a helical configuration. The springs 1206 may be wire springs or spring formed using the same material as the blades 404. The springs 1206 may be fixedly attached to a pin extending from the rotor and into the rotor connection member 412. When a pin extends from a stator and through the slot formed in the blade 404b, the blade 404b couples to the stator. The slot may also have a profile or shape such as a curve that controls where and/or how the far the blade 404b moves when the rotor rotates relative to the stator. For example, an engagement between the pin and the slot may couple the blade 404b to the stator while allowing motion of the blade 404b relative the stator along the profile of the slot. The biasing member 414a may be configured to prevent or at least reduce backlash of the blade 404b that may otherwise occur contemporaneously with actuation of rotor and the blades 404b relative to the stator to potentially increase the responsiveness and/or effectiveness of the variable aperture assembly. For example, when the rotor connection member 412 includes a pin extending from the rotor and received by a pin receiver such as an aperture, cavity, or through-hole formed in the respective blades 404b, the biasing member 414a may be positioned at or near respective rotor connection member 412 to reduce and/or eliminate any gap that may otherwise form between the pins and the pin receivers such that the respective blades 404b move with the rotor when the rotor moves with little or no delay between when the rotor begins to move (for example, rotate) and when the blades begin to actuate. In some aspects, the rotor connection member 412 may include a ring 413 that secure fits around the pin extending from the rotor 406. The ring 413 may securely fit around the pin extending from the rotor 406 so that little or no gap exists between the rotor connection member 412 and the pin extending from the rotor 406. The springs 1206 of the biasing member 414 may be fixedly attached to the ring 413 so that the springs 1206 of the biasing member 414 may be torqued as described herein. In some aspects, the ring 413 may be attached to the pin of the rotor 406 and/or the rotor connection member 412 via an adhesive. The adhesive may be permitted to cure (for example, using heat and/or ultraviolet let) before subsequent use of the variable aperture assembly 107.

In addition, the biasing member 414a use the spring force of the springs 1206 to hold or bias the pin extending from the stator against a side wall of the slot positioned at least partially through respective blade 404b so that a desired aperture diameter may be attained after actuating the blades 404b from a first position to a second position. In some aspects, the biasing member 414a may allow movement (for example, rotation) of the blade 404b about the rotor connection member 412 when the rotor and the blade 404b moves together and relative to the stator to hold or bias the pin extending from the stator for the blade 404b against a side wall of the slot. For example, due to the spring force of the springs 1206, the blade 404b may fully close the aperture 203 or may reach a desired aperture diameter after actuating from an open position by biasing or biasing the pin against a side wall of the slot. As another example, due to the spring force of the springs 1206, the blade 404b may fully open the aperture 203 or may reach a desired aperture diameter after actuating from a closed or partially closed position by biasing or biasing the pin against a side wall of the slot.

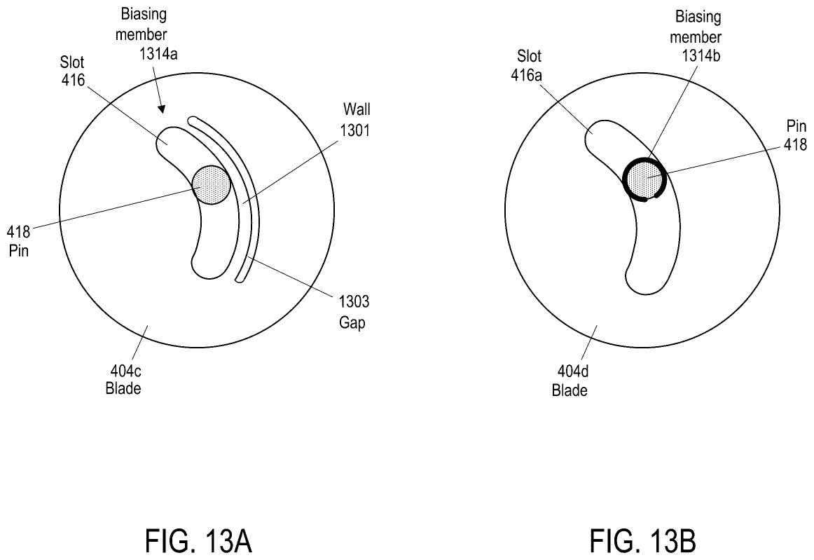

FIGS. 13A and 13B illustrate an overhead view of various biasing members of an example variable aperture assembly with anti-backlash blades, according to at least some embodiments. The blade 404c illustrated in FIG. 13A and/or blade 404d illustrated in FIG. 13B may be implemented with and/or include one or more same or similar features as the features described with respect to or illustrated in FIGS. 1, 2, 3, 4, 5, 6, 7, 8, 9, 10, 11, 12A, 12B, 12C, 14, 15, 16, 17, and 18. The example X-Y-Z coordinate system shown in FIGS. 13A and 13B may be used to discuss aspects of components and/or systems, and may apply to embodiments described throughout this disclosure.

As shown in FIG. 13A, the blade 404c may include a slot 416 having a profile as described herein and a pin 418 extending from a stator into the slot 416. The blade 404c may also have a biasing member 1314a positioned adjacent the slot 416 and the pin 418. For example, the biasing member 1314a may include a gap 1303 formed within blade 404c and may have a profile that is at least similar to the profile of the slot 416. A wall 1301 positioned between the slot 416 and the gap 1303 may be flexible to conform into the gap 1303. The wall 1301 may also have elasticity to maintain the shape of the gap 1303 when the wall 1301 is not caused to flex. For example, the pin 418 may be sized so that the diameter of the pin 418 is larger than the width of the slot 416. Thus, when the pin 418 is inserted into the slot 416, the wall 1301 flexes (due to the length of the diameter of the pin 418) into the gap 1303 so that surfaces of the slot 416 are maintained against two sides of the pin 418 biasing the pin 418 against a side of the slot 416. An engagement between the pin 418 and the slot 416 may couple the blade 404c to the stator while allowing motion of the blade 404c relative the stator along the profile of the slot 416. Using the wall 1301 and the gap 1303 of the biasing member 1314a, the biasing member 1314a may be configured to prevent or at least reduce backlash of the blade 404c that may otherwise occur contemporaneously with actuation of rotor and the blades 404c relative to the stator to potentially increase the responsiveness and/or effectiveness of the variable aperture assembly. For example, due to the wall 1301 and the gap 1303 of the biasing member 1314a, the blade 404c may fully close the aperture 203 or may reach a desired aperture diameter after actuating from an open position by biasing or biasing the pin against a side wall of the slot. As another example, due to the wall 1301 and the gap 1303 of the biasing member 1314a, the blade 404c may fully open the aperture 203 or may reach a desired aperture diameter after actuating from a closed or partially closed position by biasing or biasing the pin against a side wall of the slot. The biasing member 1314a may be used when the rotor connection member includes a press-fit mechanism or when the biasing member 1314a provides no rotational bias.

As shown in FIG. 13B, the blade 404d may include a slot 416a having a profile as at least similarly described herein and a pin 418 extending from a stator into the slot 416. The blade 404d may also have a biasing member 1314b positioned adjacent the slot 416 and the pin 418. For example, the biasing member 1314a may be a ring (for example, a c-shaped ring) or a spring 1305 that is positioned along a surface of the pin 418 and that at least partially surrounds a diameter of the pin 418. The diameter of the pin 418 may be less than the distance across the slot 416a while the diameter of the spring 1305 when the spring 1305 is at rest may be greater than the distance across the slot 416a. Thus, with the spring 1305 attached to a surface of the pin 418, when the pin 418 is inserted into the slot 416a, the spring 1305 may press against the walls of the slot 416a biasing the pin 418 against a side of the slot 416a. An engagement between the pin 418 and the slot 416a may couple the blade 404d to the stator while allowing motion of the blade 404d relative the stator along the profile of the slot 416a. Using the spring 1305 of the biasing member 1314b, the biasing member 1314b may be configured to prevent or at least reduce backlash of the blade 404d that may otherwise occur contemporaneously with actuation of rotor and the blades 404d relative to the stator to potentially increase the responsiveness and/or effectiveness of the variable aperture assembly. For example, due to the spring 1305 of the biasing member 1314b, the blade 404d may fully close the aperture 203 or may reach a desired aperture diameter after actuating from an open position by biasing or biasing the pin against a side wall of the slot. As another example, due to the spring 1305 of the biasing member 1314b, the blade 404d may fully open the aperture 203 or may reach a desired aperture diameter after actuating from a closed or partially closed position by biasing or biasing the pin against a side wall of the slot. The biasing member 1314b may be used when the rotor connection member includes a press-fit mechanism or when the biasing member 1314a provides no rotational bias.

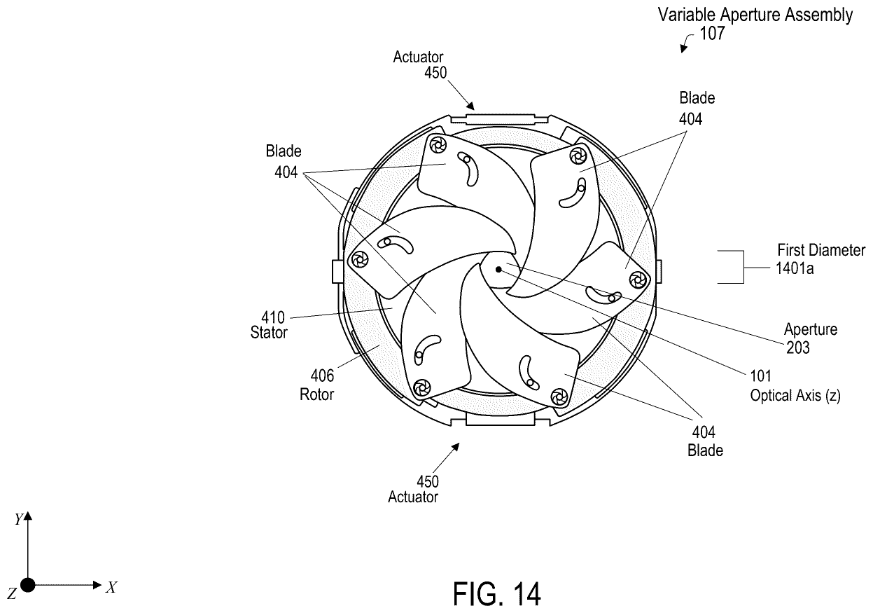

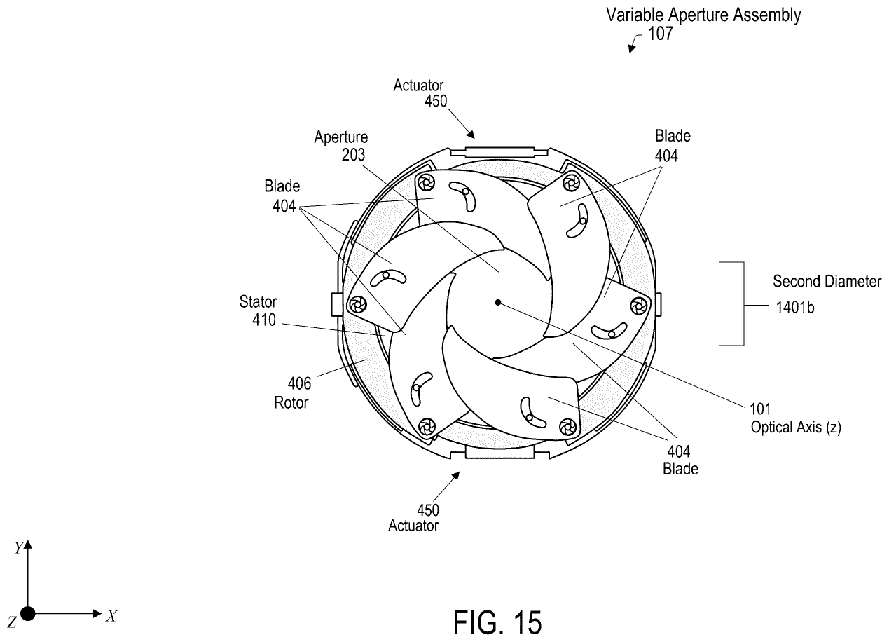

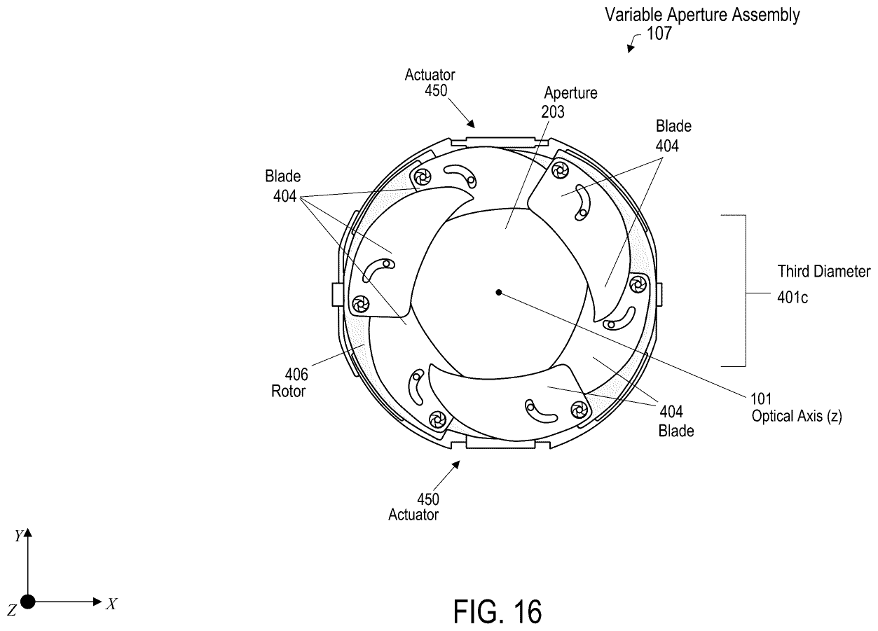

FIGS. 14, 15, and 16 illustrate overhead views of another example variable aperture assembly with anti-backlash blades that may, for example, be used to change the diameter of an aperture/opening to change an amount of light that reaches lenses of an optical assembly and/or an image sensor in small form factor cameras, according to at least some embodiments. FIG. 14 illustrates an overhead view of the variable aperture assembly in a fully actuated position. FIG. 15 illustrates an overhead view of the variable aperture assembly in a partially actuated position between the fully actuated position and a fully open position. FIG. 16 illustrates an overhead view of the variable aperture assembly in the fully open position.

As shown in FIG. 14, the variable aperture assembly 107 may be in a fully actuated position. In the fully actuated position, the variable aperture assembly 107 produces an aperture having a first diameter 1401a for allowing/permitting light to pass therethrough. The actuator(s) 450 (such SMA wire actuators and/or VCM actuators) may be used to actuate the variable aperture assembly 107. As the actuators 450 actuate, the rotor 406 is driven in a first direction causing the blades 404 to be driven towards the fully actuated position. As shown in FIG. 15, the variable aperture assembly 107 may be in a partially actuated position. In the partially actuated position, the variable aperture assembly 107 produces an aperture having a second diameter 1401b for allowing/permitting light to pass therethrough. The second diameter 1401b may be larger or greater than the first diameter 1401a of FIG. 14. As the actuators 450 actuate, the rotor 306 is driven in a second direction opposite the first direction causing the blades 404 to be driven towards and to the partially actuated position. As shown in FIG. 16, the variable aperture assembly 107 may be in a fully open position. In the fully open position, the variable aperture assembly 107 produces an aperture having a third diameter 1401c for allowing/permitting light to pass therethrough. The third diameter 1401c may be larger or greater than the first diameter 1401a of FIG. 14 and the second diameter 1401b of FIG. 15. As the actuators 450 actuate, the rotor 306 is driven further in the second direction opposite the first direction causing the blades 404 to be driven further towards and to the fully open position.

FIG. 17 illustrates a schematic representation of an example device 1700 that may include a camera (e.g., as described herein with respect to FIGS. 1, 2, 3, 4, 5, 6, 7, 8, 9, 10, 11, 12A, 12B, 12C, 13A, 13B, 14, 15, 16, and 18), in accordance with some embodiments. In some embodiments, the device 1700 may be a mobile device and/or a multifunction device. In various embodiments, the device 1700 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, application server, storage device, a television, a video recording device, a peripheral device such as a switch, modem, router, or in general any type of computing or electronic device.

In some embodiments, the device 1700 may include a display system 1702 (e.g., comprising a display and/or a touch-sensitive surface) and/or one or more cameras 1704. In some non-limiting embodiments, the display system 1702 and/or one or more front-facing cameras 1704a may be provided at a front side of the device 1700, e.g., as indicated in FIG. 17. Additionally, or alternatively, one or more rear-facing cameras 1704b may be provided at a rear side of the device 1700. In some embodiments comprising multiple cameras 1704, some or all of the cameras may be the same as, or similar to, each other. Additionally, or alternatively, some or all of the cameras may be different from each other. In various embodiments, the location(s) and/or arrangement(s) of the camera(s) 1704 may be different than those indicated in FIG. 17.

Among other things, the device 1700 may include memory 1706 (e.g., comprising an operating system 1708 and/or application(s)/program instructions 1710), one or more processors and/or controllers 1712 (e.g., comprising CPU(s), memory controller(s), display controller(s), and/or camera controller(s), etc.), and/or one or more sensors 1716 (e.g., orientation sensor(s), proximity sensor(s), and/or position sensor(s), etc.). In some embodiments, the device 1700 may communicate with one or more other devices and/or services, such as computing device(s) 1718, cloud service(s) 1720, etc., via one or more networks 1722. For example, the device 1700 may include a network interface (e.g., network interface 1710) that enables the device 1700 to transmit data to, and receive data from, the network(s) 1722. Additionally, or alternatively, the device 1700 may be capable of communicating with other devices via wireless communication using any of a variety of communications standards, protocols, and/or technologies.

FIG. 18 illustrates a schematic block diagram of an example computing device, referred to as computer system 1800, that may include or host embodiments of a camera (e.g., as described herein with respect to FIGS. 1, 2, 3, 4, 5, 6, 7, 8, 9, 10, 11, 12A, 12B, 12C, 13A, 13B, 14, 15, 16, and 17). In addition, computer system 1800 may implement methods for controlling operations of the camera and/or for performing image processing images captured with the camera. In some embodiments, the device 1700 (described herein with reference to FIG. 17) may additionally, or alternatively, include some or all of the functional components of the computer system 1800 described herein.

The computer system 1800 may be configured to execute any or all of the embodiments described above. In different embodiments, computer system 1800 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, application server, storage device, a television, a video recording device, a peripheral device such as a switch, modem, router, or in general any type of computing or electronic device.

In the illustrated embodiment, computer system 1800 includes one or more processors 1802 coupled to a system memory 1804 via an input/output (I/O) interface 1806. Computer system 1800 further includes one or more cameras 1808 coupled to the I/O interface 1806. Computer system 1800 further includes a network interface 1810 coupled to I/O interface 1806, and one or more input/output devices 1812, such as cursor control device 1814, keyboard 1816, and display(s) 1818. In some cases, it is contemplated that embodiments may be implemented using a single instance of computer system 1800, while in other embodiments multiple such systems, or multiple nodes making up computer system 1800, may be configured to host different portions or instances of embodiments. For example, in one embodiment some elements may be implemented via one or more nodes of computer system 1800 that are distinct from those nodes implementing other elements.

In various embodiments, computer system 1800 may be a uniprocessor system including one processor 1802, or a multiprocessor system including several processors 1802 (e.g., two, four, eight, or another suitable number). Processors 1802 may be any suitable processor capable of executing instructions. For example, in various embodiments processors 1802 may be general-purpose or embedded processors implementing any of a variety of instruction set architectures (ISAs), such as the x86, PowerPC, SPARC, or MIPS ISAs, or any other suitable ISA. In multiprocessor systems, each of processors 1802 may commonly, but not necessarily, implement the same ISA.

System memory 1804 may be configured to store program instructions 1820 accessible by processor 1802. In various embodiments, system memory 1804 may be implemented using any suitable memory technology, such as static random access memory (SRAM), synchronous dynamic RAM (SDRAM), nonvolatile/Flash-type memory, or any other type of memory. Additionally, existing camera control data 1822 of memory 1804 may include any of the information or data structures described above. In some embodiments, program instructions 1820 and/or data 1822 may be received, sent or stored upon different types of computer-accessible media or on similar media separate from system memory 1804 or computer system 1800. In various embodiments, some or all of the functionality described herein may be implemented via such a computer system 1800.

In one embodiment, I/O interface 1806 may be configured to coordinate I/O traffic between processor 1802, system memory 1804, and any peripheral devices in the device, including network interface 1810 or other peripheral interfaces, such as input/output devices 1812. In some embodiments, I/O interface 1806 may perform any necessary protocol, timing or other data transformations to convert data signals from one component (e.g., system memory 1804) into a format suitable for use by another component (e.g., processor 1802). In some embodiments, I/O interface 1806 may include support for devices attached through various types of peripheral buses, such as a variant of the Peripheral Component Interconnect (PCI) bus standard or the Universal Serial Bus (USB) standard, for example. In some embodiments, the function of I/O interface 1806 may be split into two or more separate components, such as a north bridge and a south bridge, for example. Also, in some embodiments some or all of the functionality of I/O interface 1806, such as an interface to system memory 1804, may be incorporated directly into processor 1802.

Network interface 1810 may be configured to allow data to be exchanged between computer system 1800 and other devices attached to a network 1824 (e.g., carrier or agent devices) or between nodes of computer system 1800. Network 1824 may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1810 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1812 may, in some embodiments, include one or more display terminals, keyboards, keypads, touchpads, scanning devices, voice or optical recognition devices, or any other devices suitable for entering or accessing data by one or more computer systems 1800. Multiple input/output devices 1812 may be present in computer system 1800 or may be distributed on various nodes of computer system 1800. In some embodiments, similar input/output devices may be separate from computer system 1800 and may interact with one or more nodes of computer system 1800 through a wired or wireless connection, such as over network interface 1810.

Those skilled in the art will appreciate that computer system 1800 is merely illustrative and is not intended to limit the scope of embodiments. In particular, the computer system and devices may include any combination of hardware or software that can perform the indicated functions, including computers, network devices, Internet appliances, PDAs, wireless phones, pagers, etc. Computer system 1800 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1800 may be transmitted to computer system 1800 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g., SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A camera, comprising:
an optical assembly having one or more lenses;
an image sensor; and
a variable aperture assembly positioned along a light path extending from an object side of the one or more lenses of the optical assembly and to the image sensor, wherein the variable aperture assembly comprises:
a rotor,
a stator,
a plurality of blades configured to vary a diameter of an aperture when the rotor rotates relative to the stator, wherein respective blades of the plurality of blades comprise a slot to receive a pin extending from the stator,
a rotor connection member for each of the respective blades for fixedly attaching the respective blades to the rotor, and
a biasing member for each of the respective blades for biasing the pin of the respective blades against a side of the slot of the respective blades.

2. The camera of claim 1, wherein the biasing member is positioned adjacent the rotor connection member.

3. The camera of claim 2, wherein the biasing member comprises a spiral spring surrounding the rotor connection member.

4. The camera of claim 1, wherein the biasing member is positioned adjacent the pin and the slot.

5. The camera of claim 4, wherein the biasing member comprises a ring wrapping at least partially around the pin and abutting the pin to bias the pin against at least the side of the slot.

6. The camera of claim 4, wherein the biasing member comprises a flexible wall of the slot configured to flex so that the pin fits through the slot and bias the pin at least against the side of the slot.

7. The camera of claim 4, wherein the variable aperture assembly further comprises a holding member for each of the respective blades for holding respective rotor connection members against pins extending from the rotor, wherein the holding member comprises a plurality of arms surrounding the rotor connection member and extending from the respective blades and towards the rotor connection member.

8. The camera of claim 1, wherein the rotor connection member comprises at least one of a press-fit mechanism or an adhesive.

9. The camera of claim 1, wherein the biasing members for the respective blades bias the variable aperture assembly toward an open position.

10. The camera of claim 1, further comprising one or more actuators configured to rotate the rotor relative to the stator to drive the plurality of blades for varying the diameter of the aperture.

11. The camera of claim 10, wherein the one or more actuators comprise at least one of a voice coil motor (VCM) actuator or a shape memory alloy (SMA) wire actuator.

12. A variable aperture assembly configured to be positioned along a light path extending from an object side of one or more lenses of an optical assembly of a camera and to an image sensor of the camera, wherein the variable aperture assembly comprises:
a rotor;
a stator;
a plurality of blades configured to vary a diameter of an aperture when the rotor rotates relative to the stator, wherein respective blades of the plurality of blades comprise a slot to receive a pin extending from the stator;
a rotor connection member for each of the respective blades for fixedly attaching the respective blades to the rotor; and
a biasing member for each of the respective blades for biasing the pin of the respective blades against a side of the slot of the respective blades.

13. The variable aperture assembly of claim 12, wherein the biasing member is positioned adjacent the rotor connection member.

14. The variable aperture assembly of claim 13, wherein the biasing member comprises a spiral spring surrounding the rotor connection member.

15. The variable aperture assembly of claim 12, wherein the biasing member is positioned adjacent the pin and the slot.

16. The variable aperture assembly of claim 15, wherein the biasing member comprises a ring wrapping at least partially around the pin and abutting the pin to bias the pin against at least the side of the slot.

17. The variable aperture assembly of claim 15, wherein the biasing member comprises a flexible wall of the slot configured to flex so that the pin fits through the slot and bias the pin at least against the side of the slot.

18. A device, comprising:
a display;
a camera;
one or more processors; and
memory storing program instructions executable by the one or more processors to cause images captured by the camera to be displayed on the display;
the camera comprising:
an optical assembly having one or more lenses;
an image sensor; and
a variable aperture assembly positioned along a light path extending from an object side of the one or more lenses of the optical assembly and to the image sensor, wherein the variable aperture assembly comprises:
a rotor,
a stator,
a plurality of blades configured to vary a diameter of an aperture when the rotor rotates relative to the stator, wherein respective blades of the plurality of blades comprise a slot to receive a pin extending from the stator,
a rotor connection member for each of the respective blades for fixedly attaching the respective blades to the rotor, and
a biasing member for each of the respective blades for biasing the pin of the respective blades against a side of the slot of the respective blades.

19. The device of claim 18, wherein the biasing member is positioned adjacent the rotor connection member.

20. The device of claim 19, wherein the biasing member comprises a spiral spring surrounding the rotor connection member.
